(19) United States
(12) Patent Application Publication
(10) Pub. No.: US 2017/0287211 A1
(43) Pub. Date: Oct. 5, 2017

(54) MEDICAL IMAGE PROCESSING APPARATUS, MEDICAL IMAGE PROCESSING METHOD, AND MEDICAL IMAGE PROCESSING SYSTEM

(71) Applicant: ZIOSOFT, INC., Tokyo (JP)

(72) Inventor: Shinichiro SEO, Tokyo (JP)

(21) Appl. No.: 15/471,196

(22) Filed: Mar. 28, 2017

(30) Foreign Application Priority Data
Mar. 29, 2016 (JP) 2016-066842

(51) Int. Cl. G06T 17/10; G06T 15/08

(52) U.S. Cl. CPC G06T 17/10; G06T 15/08

(57) ABSTRACT

A medical image processing apparatus includes a port, a processor and a display. The port acquires volume data. The processor sets a three-dimensional region in the volume data, acquires three vectors orthogonal to each other from the three-dimensional region, calculates three surfaces to which the vectors are normal lines, and generates three cross-sectional images of the volume data by setting the respective surfaces as cross-sections. The display shows the generated cross-sectional images. The processor shifts at least one surface in parallel along the corresponding normal line and regenerates a cross-sectional image in which the shifted surface is a cross-section.

### CROSS-REFERENCE TO RELATED APPLICATION

This application claims priority based on Japanese Patent Application No. 2016-066842, filed on Mar. 29, 2016, the entire contents of which are incorporated by reference herein.

### BACKGROUND OF THE INVENTION

### 1. Field of the Invention

The present disclosure relates to a medium image processing apparatus, a medium image processing method, and a medical image processing system.

### 2. Related Art

In the related art, there is known a medical image processing apparatus in which a pointing device cuts out any cross-section from volume data used to visualize a three-dimensional structure of a subject such as an inside of a human body and the cross-section is displayed as a multi planar reconstruction (MPR) cross section (see JP-A-2009-22476). There is also known a medical image processing apparatus capable of displaying three cross-sections orthogonal to each other in a human coordinate system as MPR cross-sections. There is also a medical image processing apparatus used to acquire a three-dimensional region of a subject and visualize the subject.

### SUMMARY OF THE INVENTION

In JP-A-2009-22476, it is difficult to suppress losing objectivity due to a user's manual operation and acquire three cross-sections orthogonal to each other (three orthogonal cross-sections) and suitable to observe a three-dimensional region.

The present disclosure is finalized in view of the foregoing circumstance and provides a medical image processing apparatus, a medical image processing method, and a medical image processing program capable of suppressing loss of objectivity and easily acquiring three orthogonal cross-sections suitable to observe a three-dimensional region.

A medical image processing apparatus includes a port, a processor and a display. The port acquires volume data. The processor sets a three-dimensional region in the volume data, acquires three vectors orthogonal to each other from the three-dimensional region, calculates three surfaces to which the vectors are normal lines, and generates three cross-sectional images of the volume data by setting the respective surfaces as cross-sections. The display shows the generated cross-sectional images. The processor shifts at least one surface in parallel along the corresponding normal line and regenerates a cross-sectional image in which the shifted surface is a cross-section.

A medical image processing method in a medical image processing apparatus, includes: acquiring volume data; setting a three-dimensional region in the volume data; acquiring three vectors orthogonal to each other from the three-dimensional region; calculating three surfaces to which the vectors are normal lines; generating three cross-sectional images of the three-dimensional region by setting the respective surfaces as cross-sections; displaying the generated cross-sectional images on a display; shifting at least one surface in parallel along the corresponding normal line; regenerating a cross-sectional image in which the shifted surface is a cross-section; and displaying the regenerated cross-sectional image on the display.

A medical image processing system causes a medical image processing apparatus to execute operations comprising: acquiring volume data; setting a three-dimensional region in the volume data; acquiring three vectors orthogonal to each other from the three-dimensional region; calculating three surfaces to which the vectors are normal lines; generating three cross-sectional images of the three-dimensional region by setting the respective surfaces as cross-sections; displaying the generated cross-sectional images on a display; shifting at least one surface in parallel along the corresponding normal line; regenerating a cross-sectional image in which the shifted surface is a cross-section; and displaying the regenerated cross-sectional image on the display.

According to the present disclosure, it is possible to suppress losing objectivity and easily acquire three orthogonal cross-sections.

### BRIEF DESCRIPTION OF THE DRAWINGS

FIG. 1 is a block diagram illustrating a configuration example of a medical image processing apparatus according to an embodiment;

FIG. 2 is a schematic view illustrating a method of setting three orthogonal cross-sections using a bounding box;

FIGS. 3A to 3C are schematic views illustrating an operation of dynamically displaying an MPR image by sequentially moving an MPR cross-section;

FIG. 4 is a flowchart illustrating a setting procedure for three orthogonal cross-sections formed from MPR cross-sections;

FIG. 5 is a schematic view illustrating a screen of a display on which MPR images are displayed;

FIG. 6 is a schematic view illustrating an axial cross-section according to a comparative example;

FIGS. 7A and 7B are schematic views illustrating MPR images during reproduction of a moving image;

FIGS. 8A and 8B are schematic views illustrating the MPR images during reproduction of the moving image continued from FIGS. 7A and 7B; and

FIG. 9 is a schematic view illustrating reference lines indicating the positions of the MPR cross-sections in other MPR images.

### DETAILED DESCRIPTION OF THE INVENTION

Hereinafter, embodiments of the present disclosure will be described with reference to the drawings.

In the present invention, a medical image processing apparatus includes a port, a processor and a display. The port acquires volume data. The processor sets a three-dimensional region in the acquired volume data by the port, acquires three vectors orthogonal to each other from the three-dimensional region, calculates three surfaces to which the vectors are normal lines, and generates three cross-sectional images of the volume data by setting the respective surfaces as cross-sections. The display shows the generated cross-sectional images by the processor. Based on the acquired volume data by the port, the processor shifts at least one surface in parallel along the corresponding normal line and regenerates a cross-sectional image in which the shifted surface is a cross-section, to display the regenerated cross-sectional image on the display.

### BACKGROUND TO ACHIEVEMENT OF EMBODIMENTS OF THE PRESENT DISCLOSURE

Many three-dimensional medical images are observed by referring to three orthogonal cross-sections in a subject. Many three-dimensional medical images are observed by referring to three orthogonal cross-sections of a three-dimensional region (region of interest). The three-dimensional region includes a subject in some cases. A user is accustomed to making observation using an axial plane, a coronal plane, or a sagittal plane, but it is difficult to make a diagnosis by observing the axial plane, the coronal plane, or the sagittal plane depending on the shape and orientation of a three-dimensional region. In this case, the user manually designates and acquires any MPR image, observes the MPR image, and makes a diagnosis.

However, for a subject and a three-dimensional region shown in three orthogonal cross-sections, it is not easy for the user to manually designate a desired direction in the subject and the three-dimensional region. That is, it is difficult to obtain desired three orthogonal cross-sections in the subject and the three-dimensional region. The MPR cross-sections manually set by the user are not constant and lack reproduction. Therefore, when the size of a tissue or the like is measured from the MPR cross-sections, a measurement value easily varies in each measurement and objectivity of the measurement value easily deteriorates.

Hereinafter, a medical image processing apparatus, a medical image processing method, and a medical image processing program capable of easily acquiring three orthogonal cross-sections of the three-dimensional region with suppressing loss of objectivity will be described.

### First Embodiment

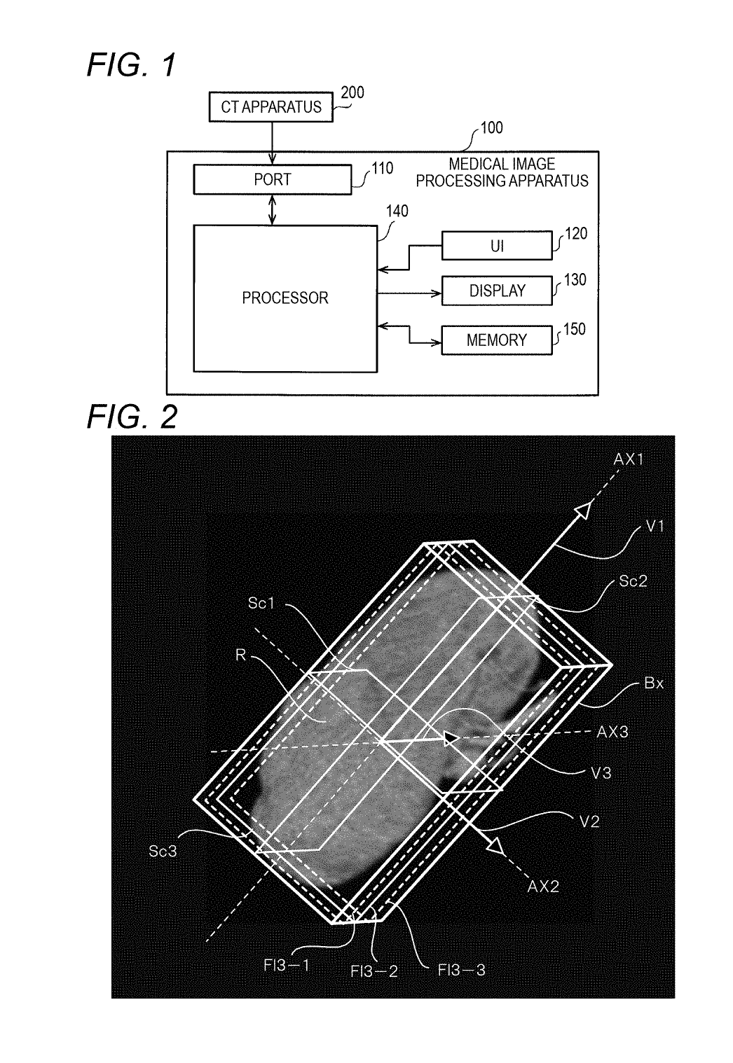

FIG. 1 is a block diagram illustrating a configuration example of a medical image processing apparatus 100 according to a first embodiment. The medical image processing apparatus 100 includes a port 110, a user interface (UI) 120, a display 130, a processor 140, and a memory 150.

A CT apparatus 200 is connected to the medical image processing apparatus 100. The medical image processing apparatus 100 acquires volume data from the CT apparatus 200 and performs a process on the acquired volume data. The medical image processing apparatus 100 is configured to include a personal computer (PC) and software mounted on the PC.

The CT apparatus 200 irradiates an organism with an X-ray and acquires images (CT image) using a difference in absorption of the X-ray by a tissue in a body. A human body can be exemplified as the organism. The organism is an example of a subject.

The plurality of CT images may be acquired in a time series. The CT apparatus 200 generates volume data including information regarding any spot inside the organism. Any spot inside the organism may include various organs (for example, a heart and a kidney). By acquiring the CT image, it is possible to obtain a CT value of each voxel of the CT image. The CT apparatus 200 transmits the volume data as the CT image to the medical image processing apparatus 100 via a wired circuit or a wireless circuit.

Specifically, the CT apparatus 200 includes a gantry (not illustrated) and a console (not illustrated). The gantry includes an X-ray generator and an X-ray detector and detects an X-ray transmitting a human body to obtain X-ray detected data by performing imaging at a predetermined timing instructed by the console. The console is connected to the medical image processing apparatus 100. The console acquires a plurality of pieces of X-ray detected data from the gantry and generates volume data based on the X-ray detected data. The console transmits the generated volume data to the medical image processing apparatus 100.

The CT apparatus 200 can also acquire a plurality of piece of three-dimensional volume data by continuously performing imaging and generate a moving image. Data of a moving image formed by a plurality of three-dimensional images is also referred to as 4-dimensional (4D) data.

The port 110 in the medical image processing apparatus 100 includes a communication port or an external apparatus connection port and acquires volume data obtained from the CT image. The acquired volume data may be transmitted directly to the processor 140 to be processed variously or may be stored in the memory 150 and subsequently transmitted to the processor 140 as necessary to be processed variously.

The UI 120 may include a touch panel, a pointing device, a keyboard, or a microphone. The UI 120 receives any input operation from a user of the medical image processing apparatus 100. The user may include a medical doctor, a radiologist, or another medical staff (paramedic staff).

The UI 120 receives an operation of designating a region of interest (ROI) in the volume data or setting a luminance condition. The region of interest may include a region of a disease or a tissue (for example, a blood vessel, an organ, or a bone).

The display 130 may include a liquid crystal display (LCD) and display various kinds of information. The various kinds of information include 3-dimesnional images obtained from the volume data. The three-dimensional image may include a volume rendering image, a surface rendering image, and a multi-planar reconstruction (MPR) image.

The memory 150 includes a primary storage device such as various read-only memories (ROMs) or random access memories (RAMs). The memory 150 may include a secondary storage device such as a hard disk drive (HDD) or a solid state drive (SSD). The memory 150 stores various kinds of information or programs. The various kinds of information may include volume data acquired by the port 10, an image generated by the processor 140, and setting information set by the processor 140.

The processor 140 may include a central processing unit (CPU), a digital signal processor (DSP), or a graphics processing unit (GPU).

The processor 140 performs various processes or control by executing a medical image processing program stored in the memory 150. The processor 140 generally controls the units of the medical image processing apparatus 100.

The processor 140 may perform a segmentation process on the volume data. In this case, the UI 120 receives an instruction from the user and transmits information of the instruction to the processor 140. The processor 140 may perform the segmentation process to extract (segment) a region of interest from the volume data in accordance with a known method based on the information of the instruction. A region of interest may be manually set in response to a detailed instruction from the user. When an observation target is decided in advance, the processor 140 may perform the segmentation process from the volume data and extracts the region of interest including the observation target tissue without an instruction from the user.

The processor 140 generates a three-dimensional image based on the volume data acquired by the port 110. The processor 140 may generate a three-dimensional image based on a designated region from the volume data acquired by the port 110. When the three-dimensional image is a volume rendering image, the three-dimensional image may include a ray sum image, a maximum intensity projection (MIP) image, or a raycast image.

Next, an operation of the medical image processing apparatus 100 will be described.

The medical image processing apparatus 100 displays three orthogonal cross-sections of an observation target tissue or the like (for example, a bone, a liver, a kidney, or a heart) on the display 130. At this time, the medical image processing apparatus 100 sets a bounding box Bx enclosing a three-dimensional region R in the three-dimensional region R including an observation target tissue or the like. In the embodiment, a case in which observation target tissue or the like is a kidney will be described mainly. The size of the bounding box Bx can have any size as long as the three-dimensional region R is enclosed.

FIG. 2 is a schematic view illustrating a method of setting three orthogonal cross-sections using the bounding box Bx.

FIG. 2 illustrates the three-dimensional region R of a volume rendering image. The bounding box Bx is set to surround the three-dimensional region R. The processor 140 acquires three eigenvectors V1, V2, and V3 indicating directions of sides of the bounding box Bx.

First, generation of the bounding box Bx will be described. In generation of the bounding box Bx, the eigenvectors V1, V2, and V3 are calculated in accordance with the following technique, for example.

When the processor 140 generates the bounding box Bx, the processor 140 performs principal component analysis on the coordinates of all the voxels that form the three-dimensional region R.

First, the processor 140 calculates a center of gravity m of the coordinates Pi (i: 0 to N−1) of all the voxels that form the three-dimensional region R in accordance with (Equation 1):

m=1/N*ΣPi (Equation 1),

where the asterisk “*” means a multiplication sign. “N” represents the number of all voxels that form the three-dimensional region R.

The processor 140 calculates a covariance matrix C in accordance with (Equation 2):

C=1/N*E(Pi−m)Pi−m)^{T} (Equation 2).

Subsequently, the processor 140 calculates (C−λjI)Vj=0 (I: unit matrix) and acquires eigenvalues λ1, λ2, and λ3 and the eigenvectors V1, V2, and V3. Further, when |λ1|>|λ2|>|λ3| is satisfied, V1 corresponding to λ1 serves the main axis of the bounding box Bx.

The processor 140 decides an orientation of a rectangular parallelepiped that is configured as the bounding box Bx based on the eigenvectors V1, V2, and V3.

Specifically, a surface to which the eigenvector V1 is a normal line and which includes coordinates Pi at which (Pi·V1) is the maximum is one of the surfaces that form the bounding box Bx. Here, “.” represents inner product calculation. A surface to which the eigenvector V1 is a normal line and which includes coordinates Pi at which (Pi-V1) is the minimum is one of the surfaces that form the bounding box Bx.

A surface to which the eigenvector V2 is a normal line and which includes coordinates Pi at which (Pi·V2) is the maximum is one of the surfaces that form the bounding box Bx. A surface to which the eigenvector V2 is a normal line and which includes coordinates Pi at which (Pi·V2) is the minimum is one of the surfaces that form the bounding box Bx.

A surface to which the eigenvector V3 is a normal line and which includes coordinates Pi at which (Pi·V3) is the maximum is one of the surfaces that form the bounding box Bx. A surface to which the eigenvector V3 is a normal line and which includes coordinates Pi at which (Pi·V3) is the minimum is one of the surfaces that form the bounding box Bx.

Thus, the medical image processing apparatus 100 can acquire six surfaces of the rectangular parallelepiped that is configured as the bounding box Bx.

The medical image processing apparatus 100 may apply an algorithm for calculating a bounding box Bx of a set of polygons described in Reference Non-Patent Literature 1 to the volume data when each surface of the bounding box Bx is acquired. In addition, a known algorithm may be used.
(Reference Non-Patent Literature 1: Eric Lengyel, “Mathematics for 3D Game Programming and Computer Graphics”, COURSE TECHNOLOGY, 2012)

The processor 140 generates three MPR cross-sections Sc1, Sc2, and Sc3 to which the eigenvectors V1, V2, and V3 are normal lines. The MPR cross-sections Sc1, Sc2, and Sc3 are examples of the three orthogonal cross-sections. The MPR cross-sections Sc1, Sc2, and Sc3 are cross-sections of the bounding box Bx. The processor 140 generates an image M1 of the MPR cross-section Sc1, an image M2 of the MPR cross-section Sc2, and an image M3 of the MPR cross-section Sc3.

The MPR cross-sections Sc1, Sc2, and Sc3 are translatable in parallel in the directions of the axes AX1, AX2, and AX3 parallel to the eigenvectors V1, V2, and V3. In FIG. 2, to move the MPR cross-section Sc3 in the direction of the axis AX3, frame images Fl3-1, Fl3-2, and Fl3-3 are illustrated as images indicating positions of the MPR cross-section Sc3 in the bounding box. In FIG. 2, the frame images Fl3-1, Fl3-2, and Fl3-3 are indicated with sizes coming into contact with the three-dimensional region R.

The parallel translation of the MPR cross-sections Sc1, Sc2, and Sc3 may be performed step by step at a given time interval or continuously by the processor 140. The parallel translation of the MPR cross-sections Sc1, Sc2, and Sc3 may be performed step by step at a given time interval or continuously by giving an instruction via the UI 120 by the user.

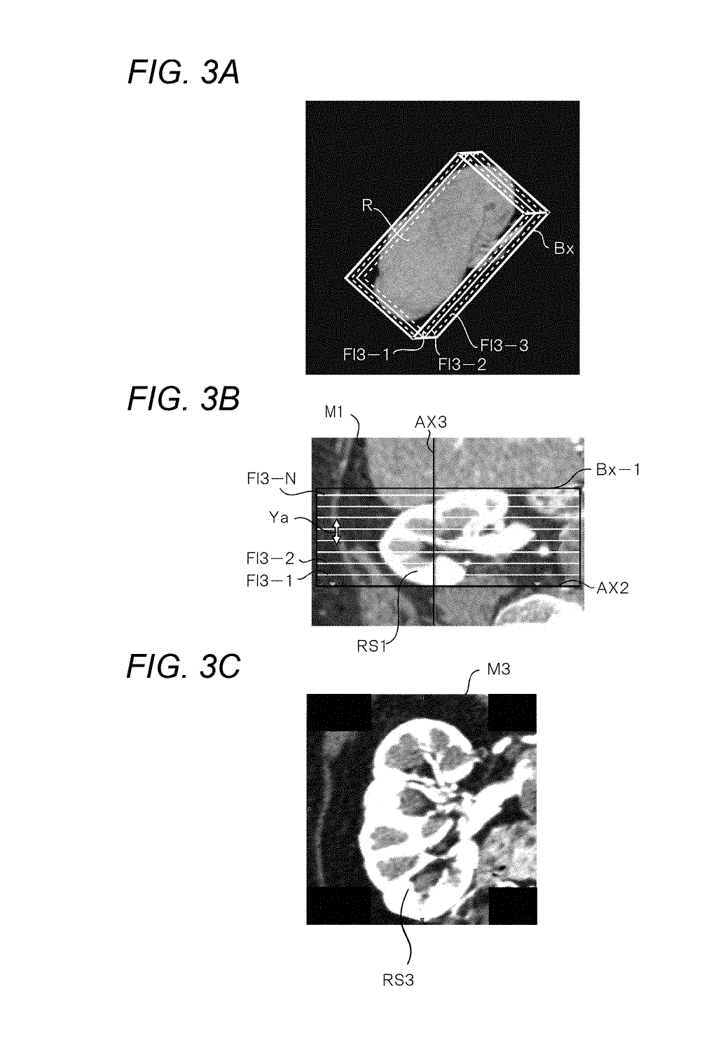

FIGS. 3A to 3C are schematic views illustrating an operation of dynamically displaying an MPR image by performing parallel translation of an MPR cross-section.

FIG. 3A illustrates the three-dimensional region R in which the bounding box Bx is set as in FIG. 2. Here, FIG. 3A illustrates the MPR cross-section Sc3 which is moved in the direction of the axis AX3 as in FIG. 2. The movement of the MPR cross-section Sc3 is expressed with changes in the frame images Fl3-1, Fl3-2, and Fl3-3.

In FIG. 3A, the frame image Fl3-2 drawn with a solid line may indicates the frame of the MPR cross-section Sc3 in which an MPR image is currently displayed. The frame images Fl3-1 and Fl3-3 drawn with dotted lines may indicate the frame of MPR cross-section Sc3 before and after the (current) MPR image.

FIG. 3B illustrates an MPR image M1. The MPR image M1 is a cross-sectional image in which the axis AX1 is a normal line. An image RS1 of a tissue or the like indicating a cross-sectional image of a tissue or the like indicated in the three-dimensional region R is included in the MPR image M1 to be transmitted. The image RS1 of a tissue or the like is surrounded by a frame image Bx-1 indicating a range in which the image RS1 can be disposed inside the bounding box Bx in the direction of the axis AX3 projected in the direction of the axis AX1.

The MPR cross-section Sc3 is translatable in parallel step by step or continuously in the direction of the axis AX3 inside the frame image Bx-1 in the axis AX3. In FIG. 3B, the MPR cross-section Sc3 is represented as line images formed by projecting the frame images Fl3-1, Fl3-2, and Fl3-3, . . . , Fl3-N of FIG. 3A.

When the frame images Fl3-1, Fl3-2, and Fl3-3, . . . , Fl3-N are sequentially selected in a direction indicated by an arrow Ya (a forward direction and a backward direction can be designated), as illustrated in FIG. 3C, the MPR image M3 corresponding to the selected frame image is displayed on the display 130. In the MPR image M3, an image RS3 of a tissue or the like of the three-dimensional region R is displayed.

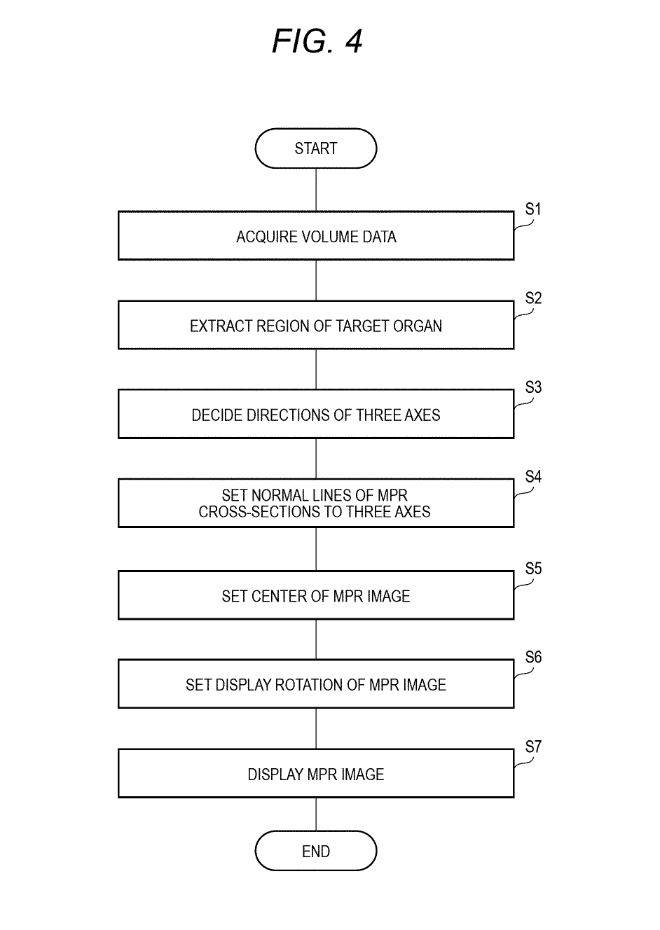

FIG. 4 is a flowchart illustrating a setting procedure for the three orthogonal cross-sections formed from MPR cross-sections Sc1, Sc2, and Sc3.

The processor 140 acquires the volume data transmitted from the CT apparatus 200 (S1).

The processor 140 extracts an observation target region included in the volume data through a known segmentation process and sets the three-dimensional region R (S2). In this case, for example, the user may roughly designate and extract a three-dimensional region via the UI 120, and then the processor 140 may accurately extract the three-dimensional region R.

The processor 140 decides the directions of the three axes AX1, AX2, and AX3 (S3). The directions of the three axes AX1, AX2, and AX3 follow the sides of the bounding box Bx surrounding the three-dimensional region R. The directions of the sides of the bounding box Bx are given by the above-described eigenvectors V1, V2, and V3. The three axes AX1, AX2, and AX3 are set so that the three axes AX1, AX2, and AX3 pass through the center of gravity G of the three-dimensional region R extracted in S2.

The processor 140 set the normal lines of the MPR cross-sections Sc1, Sc2, and Sc3 to the three axes AX1, AX2, and AX3, respectively (S4).

The processor 140 sets the centers of the MPR images M1, M2, and M3 (S5). The Centers of the MPR images M1, M2, and M3 may be set on straight lines which are parallel to the eigenvectors V1, V2, and V3 and pass through the centers of gravity G of the three-dimensional region R extracted in S2.

The processor 140 sets rotation angles in relation to the reference direction (for example, the transverse direction (horizontal direction) of the display 130) of the MPR images M1, M2, and M3 displayed on a screen GM of the display 130. Thus, the processor 140 decides display directions of the MPR images M1, M2, and M3 with respect to the reference direction of the display (S6). The setting of the display directions can also be said to set roll among pitch, roll, and yaw indicating rotation in a three-dimensional space.

Specifically, the processor 140 may decide the display direction by configuring the downward direction of the MPR image M1 to a direction along the eigenvector V2. The processor 140 may decide the display direction by configuring the downward direction of the MPR image M2 in a direction along the eigenvector V3. The processor 140 may decide the display direction by configuring the downward direction of the MPR image M3 in a direction along the eigenvector V1. Further, the processor 140 may decide the display direction by configuring the downward direction of the MPR image M1 to a direction along the eigenvector V2 and configuring the rightward direction to a direction along the eigenvector V3.

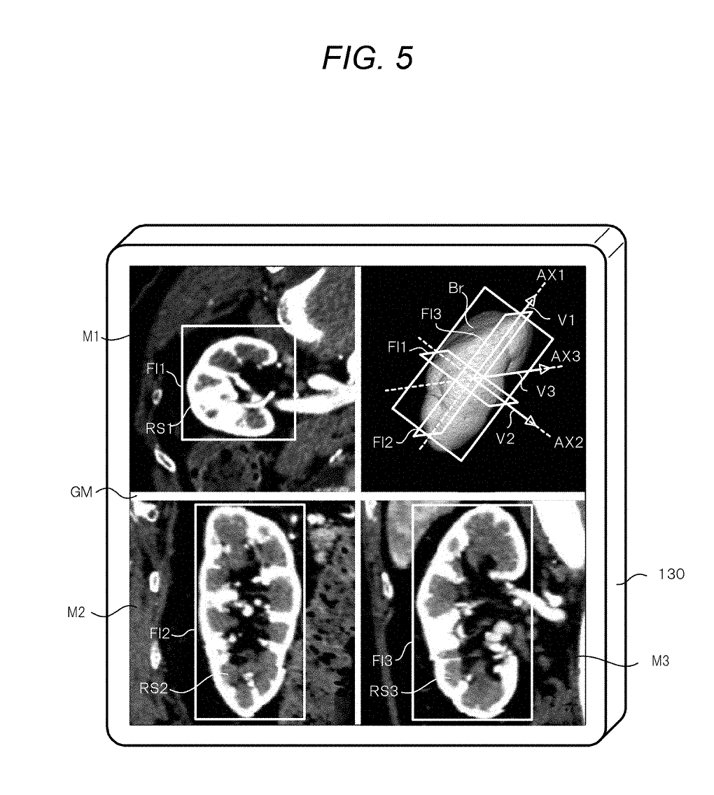

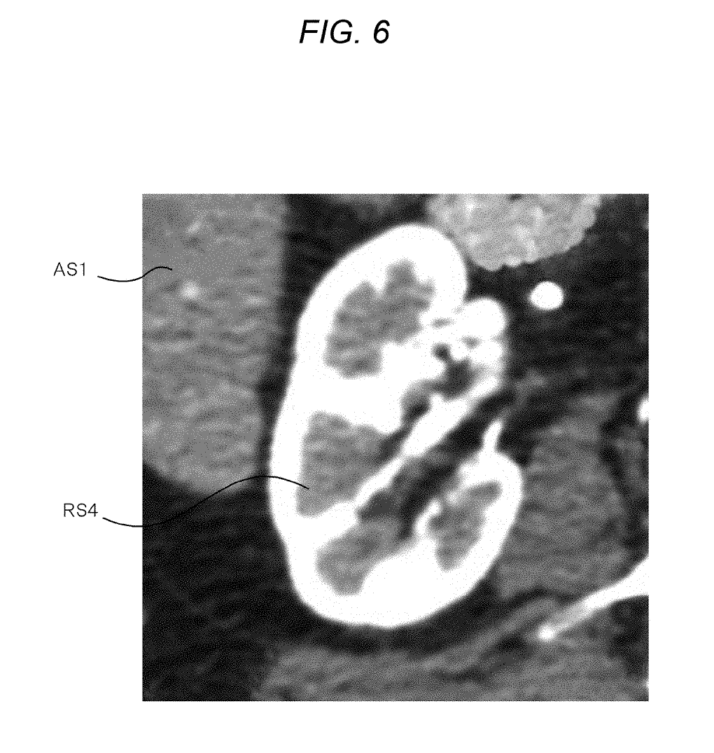

The display 130 displays the MPR images M1, M2, and M3 under the control of the processor 140, as illustrated in FIG. 5 (S7). Thereafter, the processor 140 ends the present operation.

When the volume data is discontinuous, that is, the volume data includes a plurality of tissues or the like, the processor 140 may select one tissue or the like from the plurality of tissues and configures the three-dimensional region R as a continuous region. The processor 140 may decide the directions of the three axes AX1, AX2, and AX3 of the selected continuous region.

FIG. 5 is a schematic view illustrating an image GM of the display 130 on which the MPR images M1, M2, and M3 are displayed.

In FIG. 5, the screen GM of the display 130 is divided into four parts. A volume rending image Br including the three-dimensional region R is displayed in the top right of the screen GM. The MPR images M1, M2, and M3 obtained by cutting the volume rendering image Br on the MPR cross-sections Sc1, Sc2, and Sc3 are respectively displayed in the top left, bottom left, and bottom right of the screen GM.

The display 130 may display the frame images Fl1, Fl2, and Fl3 indicating the position, size, and direction of the images RS1, RS2, and RS3 of the tissue or the like as the frame images of the bounding box Bx surrounding the three-dimensional region R on the screen GM on which the volume rendering image Br is displayed under the control of the processor 140. The display 130 may display the three axes AX1, AX2, and AX3 of the volume rendering image Br under the control of the processor 140.

At least one of the frame images Fl1, Fl2, and Fl3 may not be displayed. At least one of the axes AX1, AX2, and AX3 may not be displayed.

The image RS1 of a tissue or the like indicates a region in which there is the tissue or the like included in the MPR cross-section Sc1. The image RS2 of a tissue or the like indicates a region in which there is the tissue or the like included in the MPR cross-section Sc2. The image RS3 of a tissue or the like indicates a region in which there is the tissue or the like included in the MPR cross-section Sc3.

The layout (disposition) of the MPR images M1, M2, and M3 on the screen GM of the display 130 are, for example, fixed. The processor 140 may dispose the MPR images M1, M2, and M3 corresponding to eigenvalues in order of the magnitudes (|λ1|>|λ2|>|λ3|) of the eigenvalues λ1, λ2, and λ3.

In this case, the MPR image M1 corresponding to the axis AX1 which is a main axis is a cross-sectional image close to an axial image and has higher priority than the other MPR images M2 and M3. Therefore, the display 130 may normally display the MPR image M1 at the same screen position (for example, the top left) under the control of the processor 140. Thus, the user can easily perform an operation to make an image diagnosis quickly and precisely.

The MPR images M2 and M3 corresponding to the axes AX2 and AX3 other than the main axis may also be displayed at the same positions with the same layout. Thus, the user can easily perform an operation to make an image diagnosis quickly and precisely irrespective of the priority. The MPR image M2 provides an intuition close to a sagittal image and the MPR image M3 provides an intuition close to a coronal image.

The display 130 may display the frame images Fl1, Fl2, and Fl3 of the bounding box Bx surrounding the images RS1, RS2, and RS3 of the tissue or the like of the three-dimensional region R in the MPR images M1, M2, and M3 under the control of the processor 140.

In FIG. 5, the display 130 displays all of the positions, the sizes, and the directions of the images RS1, RS2, and RS3 of the tissue or the like by the frame images Fl1, Fl2, and Fl3 in regard to the volume rendering image Br. Instead, the display 130 may display only the positions, the sizes, or the directions of the images under the control of the processor 140.

For example, when the display 130 displays only the positions of the images RS1, RS2, and RS3 of the tissue or the like, the display 130 may display an intersection of the three axes AX1, AX2, and AX3. When the display 130 displays only the directions of the images RS1, RS2, and RS3 of the tissue or the like, the display 130 may dispose arrows or the like indicating the three axes AX1, AX2, and AX3 on the screen GM (for example, the bottom left corner of the screen GM). When the display 130 displays only the sizes of the images RS1, RS2, and RS3 of the tissue or the like, the display 130 may display a scale (ruler) on the screen GM.

The display 130 displays the images RS1, the RS2, and RS3 of the tissue or the like respectively included in the MPR images M1, M2, and M3 as a longest-diameter diameter cross-section and two short-diameter cross-sections in an ellipse of the three-dimensional region R in which it is easy to ascertain the shape of the three-dimensional region R. Accordingly, the user can easily recognize the three-dimensional region R of a kidney or the like.

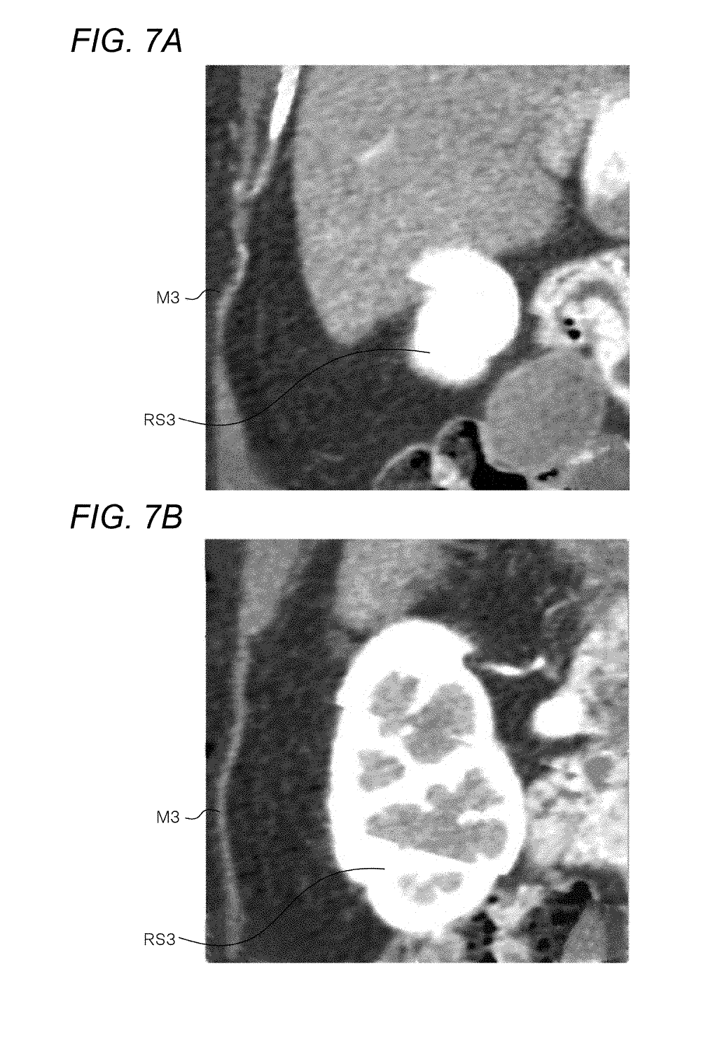

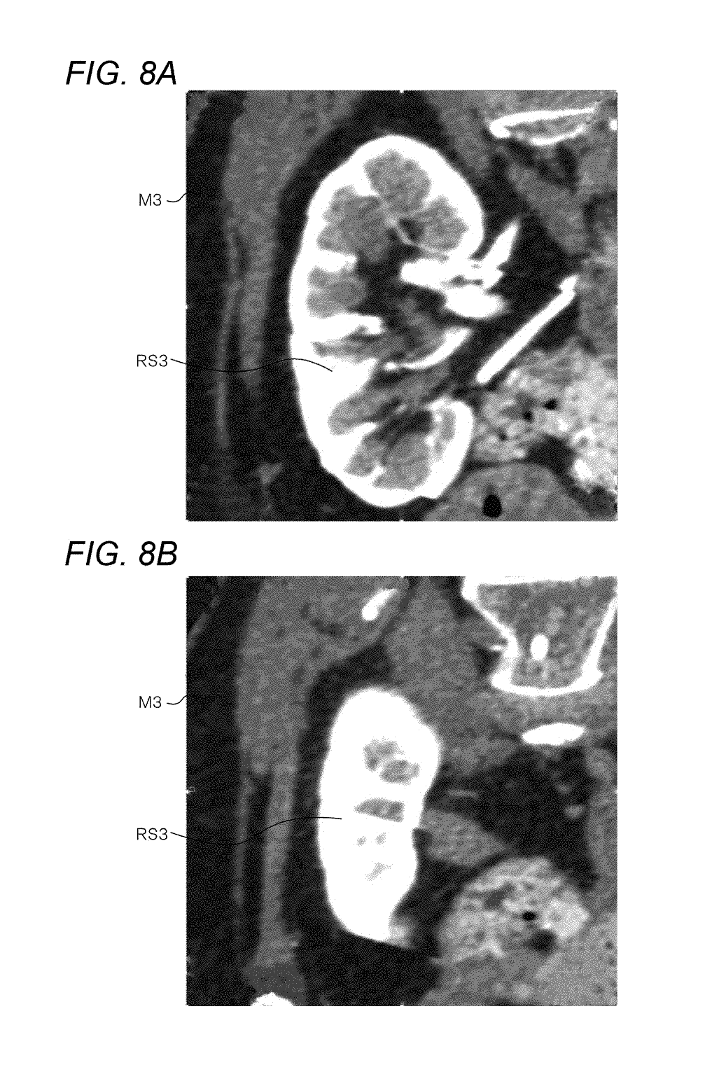

As illustrated in FIG. 5, when the volume rendering image Br and the MPR images M1, M2, and M3 are displayed on the screen GM of the display 130, the processor 140 is assumed to move one of the frame images Fl1, Fl2, and Fl3 of the bounding box Bx in one corresponding directions of the axes AX1, AX2, and AX3 on the screen GM on which the volume rendering image Br is displayed automatically or manually (via the UI 120 by the user). The processor 140 changes the MPR image corresponding to this axis in response to movement to the frame image. In this case, the MPR images are changed to still images or a moving image in order, for example, as in FIGS. 7A and 7B and FIGS. 8A and 8B to be described below.

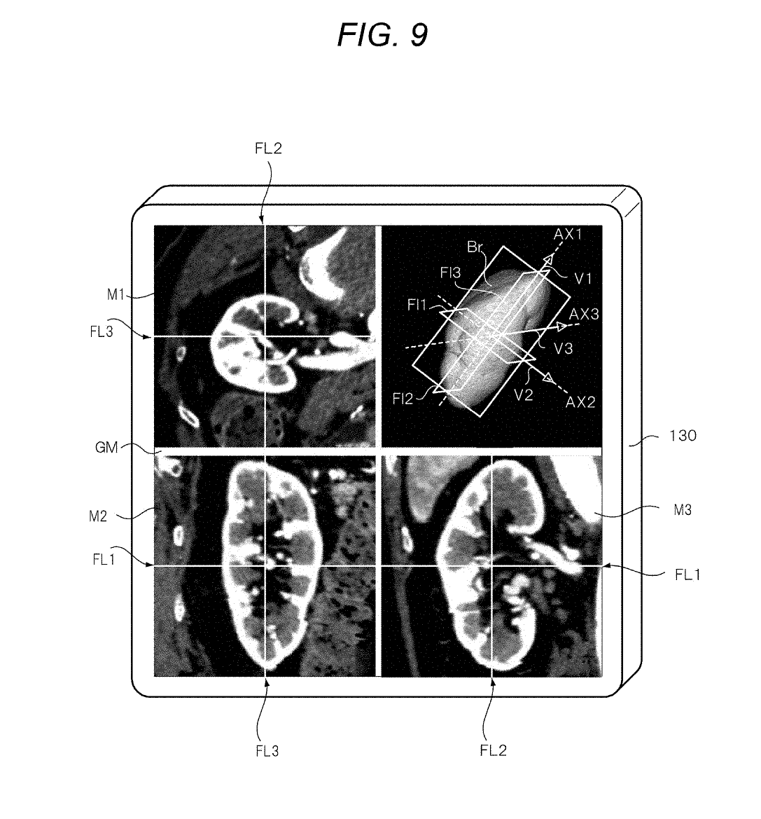

As illustrated in FIG. 9, the display 130 may display the reference lines indicating the positions of the MPR cross-sections Sc1, Sc2, and Sc3 in other MPR images.

The change in the MPR image in response to the movement of the MPR cross-section in the direction of one axis is independent from the change in the other MPR images in response to the movement of the other MPR cross-sections in the direction of the other axes, and thus there is no influence. However, the processor 140 may change the reference line which indicates the position of the MPR image translation in parallel and is displayed on the other MPR cross-sections in response to the movement.

The processor 140 may rotate the axes AX1, AX2, and AX3 in response to a drag operation on any region (for example, a region other than the three-dimensional region R) on the screen GM via the UI 120 by the user. The display 130 may rotate and display the volume rending image Br and the MPR images M1, M2, and M3 in response to the rotation of the axes AX1, AX2, and AX3 under the control of the processor 140. When one MPR image is changed due to the rotation of the axis, the processor 140 changes the two remaining MPR images to follow the change.

When the axes AX1, AX2, and AX3 are rotated under the control of the processor 140, the display 130 may display the bounding box Bx or the other reference lines. Thus, the user can easily confirm a rotation target tissue or the like.

The processor 140 may adjust the magnifying scale powers of the MPR images M1, M2, and M3 related to the display of the display 130 so that the frame images Fl1, Fl2, and Fl3 fall in the MPR images M1, M2, and M3. In particular, the processor 140 can adjust a common enlarging scale power to the MPR images M1, M2, and M3 so that the same zoom size is given to the MPR images M1, M2, and M3 and all the frame images Fl1, Fl2, and Fl3 fall.

When an operation of zooming any of the MPR images M1, M2, and M3 is received via the UI 120 by the user, the processor 140 may magnify all the MPR images M1, M2, and M3 in conjunction.

FIG. 6 is a schematic view illustrating an axial cross-section AS1 according to a comparative example. The axial cross-section AS1 includes, for example, an image RS4 of a tissue or the like of a three-dimensional region R which is a kidney. When the user views the image RS4 of the tissue or the like included in the axial cross-section AS1, for example, the user may receive an impression that the three-dimensional region R which is the kidney is oblique and may rarely ascertain the actual size or length of the kidney.

When the user gives an instruction to display a moving image via the UI 120 in S7 of FIG. 4 or there is an event such as elapse of a given time, the processor 140 may display the moving image of the MPR image selected in regard to the three-dimensional region R.

FIGS. 7A and 7B and FIGS. 8A and 8B are schematic views illustrating MPR images during reproduction of a moving image. FIGS. 7A and 7B and FIGS. 8A and 8B illustrate a case in which the moving image is displayed by translating the MPR image M3 in which the image RS2 of the tissue or the like of the three-dimensional region R is displayed in parallel in the direction of the axis AX3.

The MPR image M3 displayed in the order of FIGS. 7A and 7B and FIGS. 8A and 8B indicates a part of a screen during the reproduction of the moving image. In the MPR image M3 reproduced as the moving image, the image RS3 of the tissue or the like of the three-dimensional region R which is the kidney is displayed continuously so that the image RS3 is gradually changed.

When an image of a tissue or the like is displayed as a moving image as in FIGS. 7A and 7B and FIGS. 8A and 8B, the user can quickly ascertain the MRP image desired to be particularly focused. Accordingly, efficiency of image diagnosis by a user is expected.

In this way, the medical image processing apparatus 100 sets three orthogonal MPR cross-sections Sc1, Sc2, and Sc3 to correspond to the shape of the three-dimensional region R. Accordingly, the medical image processing apparatus 100 can quickly display the three orthogonal cross-sections conforming to a tissue or the like. For example, it is possible to appropriately respond to a request for desiring to confirm a contracted portion of a tissue or the like.

When the axis of one cross-section among the three orthogonal cross-sections is rotated, the axes of the other two cross-sections can be rotated, and thus the three MPR images M1, M2, and M3 can easily be corrected. Accordingly, the medical image processing apparatus 100 can reduce cumbersome user operations at the time of rotation of the three orthogonal cross-sections.

In this way, in the medical image processing apparatus 100 according to the embodiment, the port 110 acquires the volume data including a tissue or the like such as a bone, a liver, or a kidney. The processor 140 sets any three-dimensional region R in the volume data. The processor 140 acquires three eigenvectors V1, V2, and V3 orthogonal to each other from the three-dimensional region R. The processor 140 calculates three MPR cross-sections Sc1, Sc2, and Sc3 to which the three eigenvectors V1, V2, and V3 are normal lines. The processor 140 generates three MPR images M1, M2, and M3 in regard to the volume data in the MPR cross-sections Sc1, Sc2, and Sc3. The display 130 displays the MPR images M1, M2, and M3 on the screen GM. The processor 140 shifts the MPR cross-sections Sc1, Sc2, and Sc3 in parallel in the directions along the normal lines and regenerates the MPR images M1, M2, and M3 in which the surfaces shifted in parallel are cross-sections.

The tissue or the like is an example of a subject. The three eigenvectors V1, V2, and V3 are examples of vectors. The three MPR cross-sections Sc1, Sc2, and Sc3 are examples of three surfaces. The MPR images M1, M2, and M3 are examples of cross-sectional images.

Thus, the medical image processing apparatus 100 can suppress losing objectivity due to a user's manual operation and can easily acquire the three MPR cross-sections Sc1, Sc2, and Sc3 (three orthogonal cross-sections). The medical image processing apparatus 100 can display the MPR images M1, M2, and M3 by translating the MPR cross-sections Sc1, Sc2, and Sc3 in parallel. Accordingly, although the user does not subjectively perform an operation, the images RS1, RS2, and RS3 of a tissue or the like desired to be observed by the user can be specified, and thus reproduction can also be improved.

The medical image processing unit 100 can set not only cross-sections along a CT coordinate system such as axial cross-sections used for screening but also the MPR cross-sections Sc1, Sc2, and Sc3 on various surfaces. Accordingly, it is expect to reduce oversight of a disease by a user.

The MPR images M1, M2, and M3 may enclose the three-dimensional region R on the MPR cross-sections Sc1, Sc2, and Sc3 corresponding to the MPR images M1, M2, and M3, respectively. The images RS1, RS2, and RS3 of the tissue or the like are examples of images of a three-dimensional region including a subject.

Thus, the user can reliably ascertain the images of the tissue or the like included in the three-dimensional region.

The three-dimensional region R may be a continuous region.

Thus, since three-dimensional regions are not away from each other as in detached spots in the MPR image, the user easily observes a tissue or the like included in the three-dimensional region. It is possible to obtain the directions of the MPR images M1, M2, and M3 proper in each continuous region.

The processor 140 may set the display directions of the MPR images M1, M2, and M3 in the reference direction of the display 130 based on at least one of two eigenvectors except for the eigenvector corresponding to the MPR images M1, M2, and M3 among the three eigenvectors V1, V2, and V3.

Thus, the user easily ascertain the orientations of the MPR images M1, M2, and M3 or the orientations of the images RS1, RS2, and RS3 of the tissue or the like.

The processor 140 may generates the volume rendering image Br based on the volume data. The display 130 may display at least one piece of information among the positions, sizes, and direction of the MPR images M1, M2, and M3 in the volume rendering image Br under the control of the processor 140.

Thus, the medical image processing apparatus 100 can visually match the volume rendering image Br to the MPR images M1, M2, and M3.

The processor 140 may generate the bounding box Bx that has surrounds the three-dimensional region R and has sides along the three eigenvectors V1, V2, and V3. The display 130 may display the frame images Fl1, Fl2, and Fl3 in the volume rendering image Br under the control of the processor 140. The frame images Fl1, Fl2, and Fl3 are examples of images representing the bounding box Bx.

Thus, the medical image processing apparatus 100 can easily generate and display the bounding box which does not follow the CT coordinate system. The medical image processing apparatus 100 can visually match the volume rendering image Br to the bounding box Bx using the frame images Fl1, Fl2, and Fl3.

The display 130 may display the frame images Fl1, Fl2, and Fl3 in the MPR images M1, M2, and M3 under the control of the processor 140.

Thus, the medical image processing apparatus 100 can visually match the MPR images M1, M2, and M3 to the bounding box Bx using the frame images Fl1, Fl2, and Fl3.

The enlarging scale powers of the three cross-sectional images may be the same as each other.

Thus, when the MPR images M1, M2, and M3 are browsed in parallel, the MPR images M1, M2, and M3 can easily be compared to each other since lengths or sizes on images are uniform.

The various embodiments have been described above with reference to the drawings, but it is regardless to say that the present disclosure is not limited to the example. It should be apparent to those skilled in the art that various modification examples or correction examples can be made within the scope described in the claims and it is understood that the modification examples and the correction examples also, of course, pertain to the technical scope of the present disclosure.

For example, in the foregoing embodiment, the processor 140 acquires the three-dimensional region R through the segmentation process, but the three-dimensional region R may be generated through an operation via the UI 120 by the user. The processor 140 may change the three-dimensional region R generated once through a further new segmentation process or an operation via the UI 120 by the user. When the three-dimensional region R is changed, the processor 140 may re-calculates the eigenvectors V1, V2, and V3 and update the MPR images M1, M2, and M3.

For example, in the foregoing embodiment, the processor 140 calculates the eigenvectors V1, V2, and V3 from the three-dimensional region R through the principal component analysis, but another method may be used. For example, a circumscribed rectangular parallelepiped of the mathematically precise three-dimensional region R may be calculated.

For example, in the foregoing embodiment, the processor 140 generates the bounding box, but the bounding box may not be generated since it suffices to obtain three mutual cross-sections. For example, it suffices to calculate the eigenvectors V1, V2, and V3 from the three-dimensional region R through the principal component analysis.

In the foregoing embodiment, for example, the volume data is transmitted as an acquired CT image from the CT apparatus 200 to the medical image processing apparatus 100, as exemplified above. Instead, the volume data may be transmitted to a server on a network to be stored in the server or the like so that the volume data can be temporarily stored. In this case, the port 110 of the medical image processing apparatus 100 may acquire the volume data from the server or the like via a wired circuit or a wireless circuit as necessary or may acquire the volume data via any storage medium (not illustrated).

In the foregoing embodiment, the volume data is transmitted as an acquired CT image from the CT apparatus 200 to the medical image processing apparatus 100 via the port 110, as exemplified above. In practice, the CT apparatus 200 and the medical image processing apparatus 100 are also formed together as one product in some cases. The medical image processing apparatus 100 can also be treated as a console of the CT apparatus 200.

In the foregoing embodiment, an image is acquired by the CT apparatus 200 and the volume data including information regarding the inside of an organism is generated, as exemplified above. However, an image may be acquired by other apparatuses to generate volume data. The other apparatuses include a magnetic resonance imaging (MRI) apparatus, a position emission tomography (PET) apparatus, an angiography apparatus, and other modality apparatuses. The PET apparatus may be combined with another modality apparatus to be used.

In the foregoing embodiment, a human body has been exemplified as an organism. However, an animal's body may be used.

The present disclosure can also be expressed as a medical image processing method of defining an operation of the medical image processing apparatus. Further, as an application range of the present disclosure, a program realizing functions of the medical image processing apparatus according to the foregoing embodiment is provided to the medical image processing apparatus via a network or any of various storage media and a computer in the medical image processing apparatus reads and executes the program.

The present disclosure is useful for a medical image processing apparatus, a medical image processing method, and a medical image processing program capable of suppressing loss of objectivity and easily acquiring three orthogonal cross-sections suitable to observe a three-dimensional region.

What is claimed is:

1. A medical image processing apparatus comprising:
a port that acquires volume data;
a processor that sets a three-dimensional region in the volume data, that acquires three vectors orthogonal to each other from the three-dimensional region, that calculates three surfaces to which the vectors are normal lines, and that generates three cross-sectional images of the volume data by setting the respective surfaces as cross-sections; and
a display that displays the generated cross-sectional images,
wherein the processor shifts at least one surface in parallel along the corresponding normal line and regenerates a cross-sectional image in which the shifted surface is a cross-section.

2. The medical image processing apparatus according to claim 1,
wherein the cross-sectional image encloses the three-dimensional region on a surface corresponding to the cross-sectional image.

3. The medical image processing apparatus according to claim 1,
wherein the three-dimensional region is a continuous region.

4. The medical image processing apparatus according to claim 1,
wherein the processor sets a display direction of the cross-sectional image with respect to a reference direction of the display based on at least one of two vectors except for a vector corresponding to the cross-sectional image among the three vectors.

5. The medical image processing apparatus according to claim 1,
wherein the processor generates a volume rendering image based on the volume data, and
wherein the processor controls the display to display at least one of pieces of information regarding a position, a size, and a direction of the cross-sectional image in the volume rendering image.

6. The medical image processing apparatus according to claim 5,
wherein the processor generates a bounding box which surrounds the three-dimensional region and which has sides along the three vectors, and
wherein the processor controls the display to indicate the bounding box in the volume rendering image.

7. The medical image processing apparatus according to claim 1,
wherein the processor generates a bounding box which surrounds the three-dimensional region and which has sides along the three vectors, and
wherein the processor controls the display indicate the bounding box in the cross-sectional images.

8. The medical image processing apparatus according to claim 1,
wherein zoom the three cross-sectional images are the same as each other.

9. A medical image processing method in a medical image processing apparatus, the method comprising:
acquiring volume data;
setting a three-dimensional region in the volume data;
acquiring three vectors orthogonal to each other from the three-dimensional region;
calculating three surfaces to which the vectors are normal lines;
generating three cross-sectional images of the three-dimensional region by setting the respective surfaces as cross-sections;
displaying the generated cross-sectional images on a display;
shifting at least one surface in parallel along the corresponding normal line;
regenerating a cross-sectional image in which the shifted surface is a cross-section; and
displaying the regenerated cross-sectional image on the display.

10. A medical image processing system causing a medical image processing apparatus to execute operations comprising:
acquiring volume data;
setting a three-dimensional region in the volume data;
acquiring three vectors orthogonal to each other from the three-dimensional region;
calculating three surfaces to which the vectors are normal lines;
generating three cross-sectional images of the three-dimensional region by setting the respective surfaces as cross-sections;
displaying the generated cross-sectional images on a display,
shifting at least one surface in parallel along the corresponding normal line;
regenerating a cross-sectional image in which the shifted surface is a cross-section; and
displaying the regenerated cross-sectional image on the display.
